(19) United States
(12) Patent Application Publication
(10) Pub. No.: US 2008/0128263 A1
(43) Pub. Date: Jun. 5, 2008

(54) PROCESS FOR PRODUCING ACRYLIC ACID

(75) Inventors: Yasushi OGAWA, Yokkaichi-shi (JP); Shuhei Yada, Tokyo (JP); Kenji Takasaki, Yokkaichi-shi (JP); Yuichi Fujita, Yokkaichi-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI CHEMICAL CORPORATION, Tokyo (JP)

(21) Appl. No.: 12/024,175

(22) Filed: Feb. 1, 2008

Related U.S. Application Data
(62) Division of application No. 11/569,410, filed on Nov. 20, 2006.

(30) Foreign Application Priority Data
May 31, 2004 (JP) 2004-161256

(51) Int. Cl. B01D 3/34

(52) U.S. Cl. 203/51

(57) ABSTRACT

The present invention reduces a cost of a polymerization inhibitor required in purification of high purity acrylic acid through distillation. According to the present invention, a condensate obtained through the distillation of acrylic acid in a distillation column is fed to a flasher, to thereby obtain acrylic acid as a product from a distillate distilled from the flasher.

### TECHNICAL FIELD

The present invention relates to a method of producing acrylic acid. The present invention more specifically relates to a method of: feeding acrylic acid purified through distillation to a flasher and obtaining high purity acrylic acid as a product from an obtained distillate.

### BACKGROUND ART

An acrylic acid-containing gas obtained through vapor-phase catalytic oxidation of propane, propylene, or acrolein is collected in water or a high boiling point solvent, to thereby convert into an acrylic acid solution. Purified acrylic acid is obtained through a subsequent purification step such as extraction, diffusion, and distillation.

Recently, a market of super absorbent polymers used in disposable diapers and the like has enlarged, and a demand of acrylic acid as a raw material therefor has also increased. High purity acrylic acid generally contains acrylic acid of high purity and has reduced concentration of aldehydes such as furfural and benzaldehyde, which act as inhibitors in production of a polymerized product of acrylic acid.

It is difficult to reduce the aldehydes in purification of acrylic acid to a sufficient concentration, that is, to a concentration not causing problems in production of a polymerized product. Thus, one of: a crystallization method involving freezing acrylic acid to enhance purity (see JP 2000-290220 A, for example); and a method involving adding an agent for a reaction with aldehydes and then purifying acrylic acid through distillation (see JP S49-030312 A and S60-006635 A, for example); is usually used as a method of producing high purity acrylic acid.

In the crystallization method, an operating temperature is lower than that in purification through distillation, Thus, difficulties are hardly caused in a production process due to polymerization of acrylic acid, which is an easily polymerizable compound. Thus, stable production of high purity acrylic acid can be carried out. However, equipment required for a crystallization step is more expensive than distillation equipment. In addition, substantial electrical power is required for freezing acrylic acid. Thus, the crystallization method has economical problems.

In purification through distillation, an agent for inhibiting polymerization of acrylic acid (hereinafter, may also be referred to as “polymerization inhibitor”) is added. Examples of the polymerization inhibitor generally used in distillation of acrylic acid include: phenols such as hydroquinone and methoquinone; nitroso compounds; copper salts; manganese salts; and phenothiazine. The polymerization inhibitors may be used in combination, to thereby provide a higher polymerization inhibition effect (see JP 07-053449 A, for example).

However, in a distillation step for producing high purity acrylic acid, use of the polymerization inhibitor is rigidly limited. This is because a product specification of high purity acrylic acid in the market specifies that a type and concentration of a polymerization-inhibitor contained must be methoxyhydroquinone (hereinafter, also referred to as “methoquinone” or “MQ”) at 200 mass ppm. Thus, mixing of other polymerization inhibitors must be avoided, and a polymerization inhibitor fed from at least a column top part of a distillation column is limited to MQ.

MQ does not color acrylic acid and loses a polymerization prevention effect by removing oxygen dissolved in the acrylic acid. Thus, MQ is useful as a polymerization inhibitor in acrylic acid used as a raw material in production of an acrylic acid derivative. However, single use of MQ for preventing polymerization of acrylic acid is economically inefficient. As a result, production of high purity acrylic acid by purification through distillation requires a higher cost of the polymerization inhibitor compared with that in another production of acrylic acid by purification through distillation.

### DISCLOSURE OF THE INVENTION

The present invention has been made in view of solving the above-mentioned problems, and the present invention aims at reducing a cost of a polymerization inhibitor required in purification of high purity acrylic acid through distillation.

The inventors of the present invention have found that: when a high boiling point compound except MQ is used/used in combination as a polymerization inhibitor fed to a reflux line for refluxing part of a condensate to a distillation column in the distillation column for high purity acrylic acid, the polymerization inhibitor is also mixed into the condensate from a column top; but when the condensate is treated in a flasher, a concentration of the polymerization inhibitor except MQ can be substantially reduced in a distillate to be obtained. This enables reduction of MQ fed to the reflux line.

The inventors of the present invention have also found that a feed amount of MQ to a reflux line can be reduced by providing a feed position of a polymerization inhibitor to a distillation column between the reflux line in the distillation column and a feed line for feeding acrylic acid as a raw material to the distillation column and by feeding a polymerization inhibitor except MQ from the position, and thus have completed the present invention.

That is, the present invention relates to a method of producing acrylic acid comprising: feeding a condensate obtained through distillation of acrylic acid in a distillation column to a flasher; and obtaining acrylic acid as a product from a distillate distilled from the flasher.

Further, the inventors of the present invention have found that an amount of MQ used in production of high purity acrylic acid can be reduced depending on a type of polymerization inhibitor fed to a reflux liquid and a reflux position of the reflux liquid in a distillation column.

That is, the present invention relates to a method of producing acrylic acid comprising: distilling acrylic acid in a distillation column; feeding methoquinone to an obtained condensate; refluxing part of the condensate, to which methoquinone was fed, to the distillation column as a reflux liquid; and obtaining acrylic acid as a product from another part of the condensate, to which methoquinone was fed, wherein the method comprises: further feeding methoquinone to the reflux liquid; refluxing the reflux liquid, to which methoquinone was further fed, to a column top part of the distillation column; and feeding an agent for preventing polymerization of acrylic acid from a lower position compared with a position to which the reflux liquid is refluxed to the distillation column in the distillation column.

### BRIEF DESCRIPTION OF THE DRAWINGS

FIG. 1 is a diagram showing an acrylic acid production apparatus used in a first embodiment of the present invention.

FIG. 2 is a diagram showing an acrylic acid production apparatus used in a second embodiment of the present invention.

FIG. 3 is a diagram showing an example of a standard production apparatus for high purity acrylic acid.

### BEST MODE FOR CARRYING OUT THE INVENTION

Acrylic acid produced in the present invention refers to acrylic acid used as a raw material for super absorbent polymers or the like. A product specification thereof in the market usually specifies a concentration of a polymerization inhibitor, which must be about 200 mass ppm of MQ, in addition to purity or color of acrylic acid, a concentration of impurities therein, and the like (Safety guidelines for handling acrylic acid and acrylates, 6th revision, Japan Acrylate Industry Association), 200 mass ppm of MQ is a sufficient concentration for storing acrylic acid under appropriate conditions, but is an insufficient concentration for long-term and stable purification of acrylic acid through distillation using commercial equipment. Thus, in order to attain prevention of polymerization in the distillation equipment using MQ, much more MQ feed is indispensable.

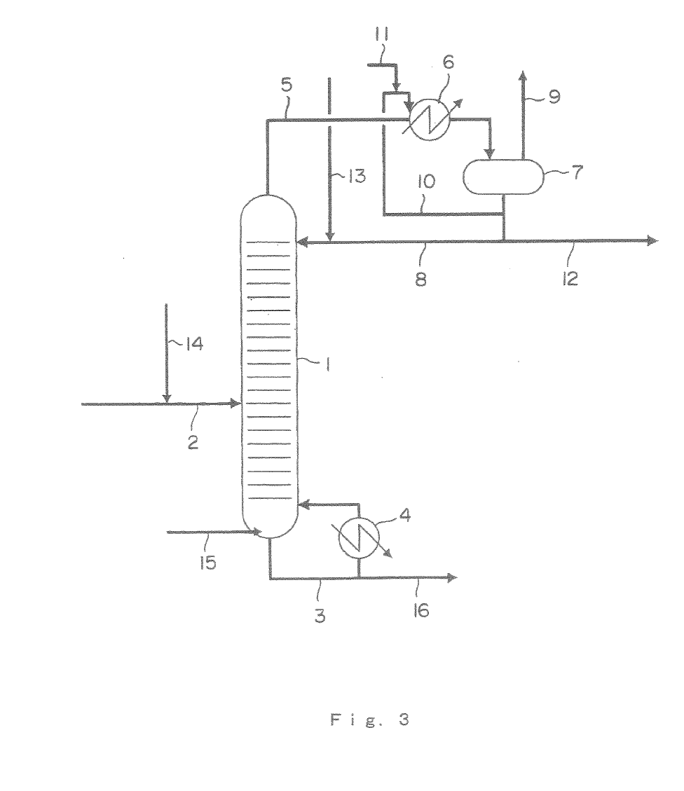

FIG. 3 shows a standard example for producing acrylic acid having an MQ concentration of about 200 mass ppm. A production apparatus shown in FIG. 3 is provided with: a distillation column 1, a feed line 2 for feeding acrylic acid as a raw material to the distillation column 1; a circulation line 3 for drawing part of a column bottom liquid in the distillation column 1 and returning the column bottom liquid to the distillation column; a reboiler 4 for heating the column bottom liquid in the circulation line 3; an overhead line 5 for discharging a vapor of acrylic acid from the distillation column 1; a condenser 6 for condensing the vapor of acrylic acid in the overhead line 5; a reflux drum 7 for receiving acrylic acid condensed in the condenser 6; a reflux line 8 for refluxing part of the condensate received in the reflux drum 7 to the distillation column 1; and a vacuum line 9 connected to vacuum equipment for reducing a pressure in the distillation column 1.

A reflux liquid feed line 10 for feeding part of the condensate to the condenser 6 and spraying the condensate in an inlet of the condenser 6 is connected to the reflux line 8. A first polymerization inhibitor feed line 11 for feeding a polymerization inhibitor is connected to the reflux liquid feed line 10.

A distillate draw line 12 for drawing part of the condensate as a product (distillate) is connected to the reflux line 8 downstream of the reflux liquid feed line 10, A second polymerization inhibitor feed line 13 for feeding a polymerization inhibitor to the condensate to be ref luxed to the distillation column 1 (hereinafter, such a condensate may also be referred to as “reflux liquid”) is connected to the reflux line 8 downstream of the distillate draw line 12.

A third polymerization inhibitor feed line 14 for feeding a polymerization inhibitor is connected to the feed line 2. A fourth polymerization inhibitor feed line 15 for feeding air as a polymerization inhibitor is connected to a bottom part of the distillation column. A bottoms draw line 16 for drawing part of the column bottom liquid from the production apparatus as a bottoms is connected to the circulation line 3,

A vapor of acrylic acid is condensed by the condenser 6 provided in the overhead line 5. An amount of a polymerization inhibitor going with the vapor of acrylic acid is small, and thus feed of the polymerization inhibitor to the condenser 6 is indispensable for a stable operation (see JP 12-344688 A). MQ is used as the polymerization inhibitor fed to the overhead line 5 from the first polymerization inhibitor feed line 11. An addition amount thereof is held within a range in which an MQ concentration in the distillate does not exceed the product specification.

MQ is also used as the polymerization inhibitor added to the reflux line 8 from the second polymerization inhibitor feed line 13. This is because part of the liquid fed to a column top part of the distillation column 1 from the reflux line 8 is spread and entrained (hereinafter, may also be referred to as “entrainment”) with the vapor elevating through the distillation column 1 to be fed to the overhead line 5, and if a polymerization inhibitor except MQ is used in the reflux line 8, the polymerization inhibitor may also be mixed in a distillate as a product, and a quality of high purity acrylic acid cannot be satisfied. A feed amount of MQ varies depending on specifications or operating conditions of the distillation column 1, but is normally 500 to 2,000 mass ppm as a concentration in the reflux liquid.

Acrylic acid fed to the distillation column 1 from the feed line 2 usually contains a polymerization inhibitor which stems from a previous purification step. However, a polymerization inhibitor is further added thereto from the third polymerization inhibitor feed line 14 as required. The polymerization inhibitor as used herein is not limited to MQ. A type and amount of an agent used is determined by evaluating a polymerization prevention effect and an economical efficiency comprehensively.

In the present invention, a condensate obtained through distillation of acrylic acid in a distillation column is fed to a flasher, to thereby obtain acrylic acid as a product from a distillate distilled from the flasher. In the present invention, the distillate itself may be regarded as product acrylic acid or the distillate, to which an additive such as a polymerization inhibitor is added, including MO added may be regarded as product acrylic acid.

According to the present invention, even if a polymerization inhibitor except MQ is mixed into a condensate from a distillation column, the polymerization inhibitor is separated from a vapor of acrylic acid in a flasher afterwards. Thus, a polymerization inhibitor except MQ can be used in distillation of acrylic acid in the distillation column, and an amount of MQ used can be reduced in production of high purity acrylic acid.

In the present invention, it is preferable to reflux part of the condensate to the distillation column and to add a polymerization inhibitor except MQ as an agent to a reflux liquid refluxed to the distillation column, from the viewpoint of enhancing the economical efficiency in production of high purity acrylic acid. A polymerization inhibitor except MQ fed to the reflux liquid is not particularly limited so long as it is an agent for preventing polymerization of acrylic acid. A single polymerization inhibitor or a plurality of polymerization inhibitors each having a boiling point of 280° C. or higher may be selected. Examples thereof include hydroquinone, phenorhiazine, a copper complex, and a manganese complex. A concentration of each of the polymerization inhibitors in the reflux liquid is preferably less than 1,000 ppm. The use of a polymerization inhibitor having a low boiling point and/or in a high concentration is not preferable because a contamination into high purity acrylic acid as a product increases. Further, the polymerization inhibitors can be used in combination with MQ.

In acrylic acid as a raw material used in purification through distillation, a polymerization of aldehydes is normally carried out by addition of me reap tan or a hydrazine compound before feed to the distillation column for facilitating separation of the aldehydes therein.

In the present invention, the addition/reaction can be carried out after obtaining of a distillate of the distillation column and before the feed to the flasher. That is, mercaptan or a hydrazine compound can be added to a condensate obtained through distillation of acrylic acid, and the resultant liquid can be fed to the flasher. According to such a method, a concentration of aldehydes in acrylic acid is reduced through a distillation operation, and thus an amount of mercaptan or a hydrazine compound used for polymerization of aldehydes can be reduced. Such addition/reaction may be carried out stepwise before and after the purification step through distillation.

In the flasher, entrainment must be suppressed for maintaining a product quality. Examples of methods of preventing entrainment include: a method of preventing elevation of droplets by making a height from a liquid surface to a column top in a flash column higher or reducing a gas flow rate; and a method of trapping droplets by a baffle. a wire mesh, or the like. Acrylic acid is an easily polymerizable compound, and the use of equipment having a complex shape for trapping droplets easily causes clogging due to polymerization of acrylic acid. Thus, reduction of entrainment by reducing the gas flow rate is important in the present invention.

To be specific, an upward linear velocity of a gas in a vertical direction is preferably less than 10 m/s, and a mass velocity thereof is preferably less than 1 kg/m²s in a flash column. A vapor in she flasher at such linear velocity and mass velocity can further prevent mixing of a polymerization inhibitor except MQ due to entrainment in the flasher.

A bottoms from the flasher may be disposed of or circulated to any of the steps in purification of acrylic acid, but is circulated to a column bottom part of the distillation column, for example.

In the present invention, it is preferable to feed methoquinone to a condensate obtained through distillation of acrylic acid and a reflux liquid, to reflux the reflux liquid to which methoquinone was fed to a column top part of a distillation column, and to feed an acrylic acid solution of an agent containing acrylic acid and the agent into the distillation column from a position between a feed position of acrylic acid as a raw material and the column top part in the distillation column.

In the distillation column, polymerization occurs more easily in a column lower part at higher temperatures, thereby requiring a larger amount of a polymerization inhibitor. The standard method shown in FIG. 3 requires a polymerization inhibitor (MQ) fed from a column top part in a sufficient amount for inhibiting polymerization in a region from the column top part to the feed line.

According to the above-mentioned method of the present invention, the polymerization inhibitor needs to be fed from the column top part only in a sufficient amount for inhibiting polymerization in the region from the column top part to the feed line of the polymerization inhibitor therebelow, that is, in a region at lower temperatures compared with that in the standard method of producing acrylic acid. The method of the present invention described above allows reduction of the polymerization inhibitor fed from the column top part, and thus, if the polymerization inhibitor is MQ, an MQ consumption can be reduced directly. If the polymerization inhibitor includes another polymerization inhibitor, an amount of the other polymerization inhibitor mixed into the distillate is reduced, thereby facilitating purification by a subsequent flashing operation.

The acrylic acid solution of the agent is not particularly limited so long as the liquid contains acrylic acid and the agent. Examples of the acrylic acid solution include: a mixed solution of acrylic acid as a raw material and an agent; a mixed solution of the reflux liquid and an agent; and a mixed solution of a column bottom liquid of the flasher and an agent.

A feed position of the acrylic acid solution of the agent in the distillation column is preferably close to the column top part from the viewpoint of reducing an amount of MQ used. To be specific, the acrylic acid solution of the agent is preferably fed to a second to fourth tray from the column top part in a plate column and to a position at a packing height in the range of 0.5 to 2.5 m to the column top in a packed column.

If a reflux liquid containing MQ is refluxed to the column top part of the distillation column, the distillation column is provided with preferably at least one tray, more preferably 2 to 3 trays each having a small opening ratio compared to those of conventional trays used for purification through separation from the viewpoint of preventing entrainment of another polymerization inhibitor from the column top. The trays are preferably provided at a smaller interval than that of the conventional trays from the viewpoint of preventing entrainment of another polymerization inhibitor or the like.

In the present invention, if entrainment of another polymerization inhibitor is sufficiently prevented by refluxing the reflux liquid containing MQ to the column top part of the distillation column, a flasher for evaporating a condensate thereafter can be dispensed with.

A first embodiment of the present invention will be described below.

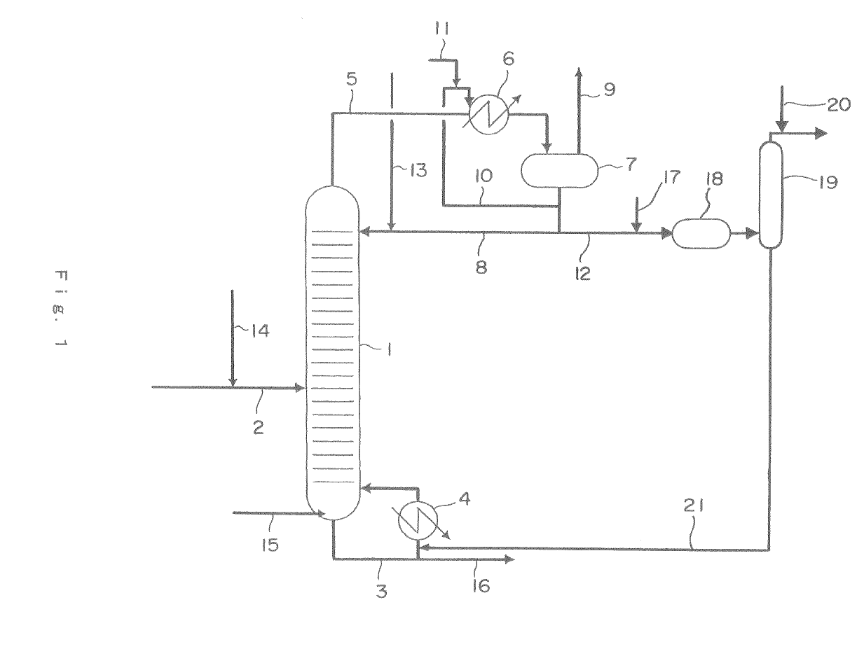

This embodiment employs a production apparatus of acrylic acid as shown in FIG. 1. The production apparatus is provided with, in addition to the structure of the above-mentioned standard production apparatus; a polymerization accelerator feed line 17 for feeding a hydrazine compound as a polymerization accelerator for polymerizing aldehydes to the distillate draw line 12; a reaction tank 18 for reacting on the aldehydes and the hydrazine compound in acrylic acid in the distillate draw line 12; a flasher 19 for evaporating an acrylic acid liquid after the polymerization reaction; a condenser (not shown) for condensing a vapor from a top part of the flasher 19; an MQ feed line 20 for feeding MQ to the obtained condensate; and a column bottom liquid feed line 21 for returning the column bottom liquid of the flasher 19 to the reboller 4. The second polymerization inhibitor feed line 13 serves as a device of feeding a polymerization inhibitor except MQ.

In the production apparatus, acrylic acid as a raw material, to which a polymerization inhibitor except MQ was fed, is fed to the distillation column 1 from the feed line 2. Acrylic acid fed to the distillation column 1 is heated in the reboiler 4, and a thus-formed vapor is fed to the condenser 6 from the overhead line 5. Air is fed no the column bottom liquid of the distillation column 1 from the fourth polymerization inhibitor feed line 15.

In the condenser 6, the vapor of acrylic acid is condensed, and a condensate of acrylic acid is formed. A mixed liquid of an acrylic acid solution of MQ fed from the first polymerization inhibitor feed line 11 and acrylic acid fed from the reflux liquid feed line 10 is sprayed into the condenser 6.

The sprayed condensate of acrylic acid containing MQ is received in the reflux drum 7. Part of the condensate received in the reflux drum 7 is fed to the condenser 6 through the reflux liquid feed line 10. Other part thereof is fed to the reflux line 8, and other part thereof is fed to the distillate draw line 12.

To the condensate (reflux liquid) fed to the reflux line 8, a polymerization inhibitor except MQ having a boiling point of 280° C. or higher is fed from the second polymerization inhibitor feed line 13. The reflux liquid, to which the polymerization inhibitor was fed, is refluxed to the column top part of the distillation column 1.

To the condensate fed to the distillate draw line 12, a hydrazine compound is fed from the polymerization accelerator feed line 17. The condensate, to which the hydrazine compound was fed, is fed to the reaction tank 18 and stays in the reaction tank 18 for a sufficient time period for a polymerization reaction.

The condensate subjected to the polymerization reaction is fed to the flasher 19. The polymerization inhibitor except MQ, which may be present in the condensate, has a substantially higher boiling point than a boiling point of acrylic acid. Polymerized products of aldehydes, which may be present in the condensate, each have a substantially higher boiling point than a boiling point of acrylic acid. Thus, the condensate fed to the flasher 19 is evaporated. The vapor of acrylic acid is discharged from the top part of the flasher 19, and the polymerized products of aldehydes and the polymerization inhibitor remain in the column bottom liquid.

The vapor of acrylic acid discharged from the top part of the flasher 19 is condensed in the condenser. To the obtained condensate of acrylic acid, an appropriate amount of MQ is fed from the MQ feed line 20, to thereby provide product acrylic acid having an MQ concentration of 200 mass ppm.

The column bottom liquid of the flasher 19 is fed to the column bottom part of the distillation column 1 through the column bottom liquid feed line 21 and the reboiler 4 to be reused in purification of acrylic acid through distillation.

In this embodiment, the distillate obtained from purification through distillation is fed to the flasher 19, and high purity acrylic acid is obtained from the distillate of the flasher 19. Thus, even if part of the polymerization inhibitor except MQ is mixed into she distillate of a distillation device, a concentration of the polymerization inhibitor in the distillate obtained through a subsequent flashing operation can be substantially reduced.

In this embodiment, MQ is fed to the distillate of the flasher 19 from the MQ feed line 20, to thereby provide high purity acrylic acid having an adjusted MQ concentration.

In this embodiment, the polymerization of acrylic acid between the feed line and the column bottom liquid is mainly prevented by the feed of the polymerization inhibitor from the third polymerization inhibitor feed line 14. The polymerization of acrylic acid in the column bottom liquid is mainly prevented by the feed of air from the fourth polymerization inhibitor feed line 15. The polymerization of acrylic acid between the column top part of the distillation column 1 and the feed line 2 is mainly prevented by the feed of the polymerization inhibitor from the second polymerization inhibitor feed line 13. The polymerization inhibitors except MQ are used for such polymerization inhibitors. As described above, the use of polymerization inhibitors except MQ to the reflux liquid or the like of the distillation device can drastically reduce an amount of MQ used in production of high purity acrylic acid.

An MQ concentration in acrylic acid, which is the distillate from the flasher 19, is reduced through a flashing operation as well, and thus MQ must be fed to the distillate of the flasher again. However, an amount thereof is smaller than a feed amount thereof to the reflux line 8 in the above-mentioned standard example, thereby enabling a drastic reduction in an amount of MQ used.

In this embodiment, the polymerization of aldehydes in acrylic acid is carried out after purification through distillation. Aldehydes in acrylic acid are separated from acrylic acid through distillation in the distillation column 1, and thus, an amount of the hydrazine compound required for polymerization of aldehydes can be reduced in this embodiment. Similar effects can be obtained when melcaptans are used for polymerization of aldehydes by feeding mercaptans from the polymerization accelerator feed line 17 and using a packed column packed with an ion-exchanged resin as an acid catalyst instead of the reaction tank 18.

In this embodiment, the column bottom liquid of the flasher 19 is fed to the column bottom part of the distillation column 1 and is used for purification of acrylic acid through distillation. Thus, acrylic acid can be recovered from the column bottom liquid of the flasher 19, and an amount of liquid waste can be reduced.

A second embodiment of the present invention will be described.

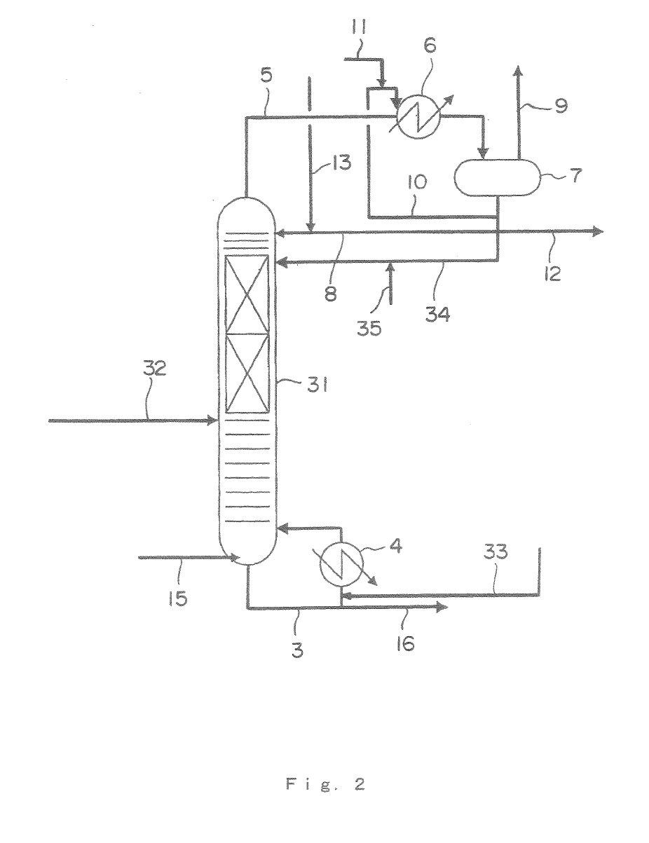

This embodiment employs a production apparatus of acrylic acid as shown in FIG. 2. The production apparatus has the same structure as the above-mentioned standard production apparatus except that the production apparatus is provided with; a distillation column 31 instead of the distillation column 1; a first feed line 32 and a second feed line 33 instead of the feed line 2; a second reflux line 34 which branches from the reflux line 8 (referred to as a “first reflux line” in this embodiment); and a fifth polymerization inhibitor feed line 35 for feeding a polymerization inhibitor to the second reflux line.

The distillation column 31 is provided with 3 dual flow trays (also referred to as “DF trays”) in an upper part. The DF trays are provided to prevent entrainment from below the trays, and the trays basically have no distillation separation ability. The DF trays each have a smaller opening ratio and are provided at a smaller interval compared with those of other trays used for distillation in the distillation column 31.

The first feed line 32 and the second feed line 33 are each a line for feeding acrylic acid as a raw material to the distillation column 31. Acrylic acid, to which a polymerization inhibitor was fed, or a reusable liquid containing acrylic acid such as a column bottom, liquid discharged in other steps may be fed from the lines. Alternatively, a flasher may be provided downstream of the distillate draw line 12 in the same manner as in the first embodiment, and a bottoms of the flasher may be fed from the lines.

The first reflux line 8 is a line for refluxing a reflux liquid to a column top part of the distillation column 31, more specifically to the uppermost DF tray. The second reflux line 34 is a line for refluxing a reflux liquid to a lower position from a reflux position of the second reflux line 8, more specifically to a tray or a packed layer just below the lowermost DF tray. A flow rate of the reflux liquid in the second reflux line 34 is set to a much larger value than a flow rate of the reflux liquid in the first reflux line 8, more specifically about 7 to 15 times larger than the flow rate thereof. The second polymerization inhibitor feed line 13 is a line for feeding MQ, and the fifth polymerization inhibitor feed line 35 is a line for feeding an agent such as phenothiazine or hydroquinone.

Acrylic acid distilled in the distillation column 31 is condensed in the condenser 6, and the formed condensate is received in the reflux drum 7. Part of the condensate received in the reflux drum 7 is fed to the reflux liquid feed line 10 and the distillate draw line 12 as described above, and in addition, to each of the first reflux line 8 and the second reflux line 34.

To the first reflux line 8, to which a smaller amount of the reflux liquid was fed compared with that to the second reflux line 34, MQ is fed from the second polymerization inhibitor feed line 13 in an amount for preventing polymerization between the column top part of the distillation column 31 and the reflux position of the second reflux line 34.

To the second reflux line 34, to which a larger amount of the reflux liquid was fed compared with that to the first reflux line 8, the agent is fed from the fifth polymerization inhibitor feed line 35 in an amount for preventing polymerization in the distillation column 31 in a lower part from the reflux position of the second reflux line 34.

In the distillation column 31, 3 DF trays provided in the upper part of the distillation column 31 prevent entrainment therebelow. Further, the condensate, to which MQ was fed, is fed to the uppermost DF tray, to thereby prevent polymerization in the upper part of the distillation column 31, Droplets each containing MQ are spread and discharged from the column top of the distillation column 31 by a reflux flow from the first reflux line 8. The entrainment provides no adverse effects on a quality of acrylic acid as a product.

An amount of the reflux liquid in the first reflux line 8 is smaller than the amount of the reflux liquid in the second reflux line 34. Thus, an amount of MQ required is drastically reduced compared with that of the standard production apparatus when an MQ concentration in the reflux liquid in the first reflux line 8 is set to the same concentration or larger as that in the standard production apparatus.

If the agent is fed to acrylic acid as a raw material fed from the first feed line 33 or the second feed line 34, an amount of the agent fed to the second reflux line 34 from the fifth polymerization inhibitor feed line 35 is reduced to an amount for preventing polymerization in the distillation column 31 between the reflux position of the second reflux line 34 and the first feed line 32 or the second feed line 33.

The condensate fed to the distillate draw line 12 may be used as it is as product acrylic acid depending on a concentration of the agent except MQ or the product specification, may be subjected to polymerization in the same manner as in the above-mentioned first embodiment, or may be fed as it is to the flasher.

In this embodiment, MQ is fed to the first reflux line 8 for refluxing a reflux liquid to the uppermost part of the distillation column 31 and an agent is fed to the second reflux line 34 for refluxing a reflux liquid to a lower position from the reflux position of the first reflux line 8. Thus, the polymerization in a large part of the distillation column 31 can be prevented by the agent, and mixing of the agent into the product due to entrainment can be prevented.

In this embodiment, an amount of MQ fed to the first reflux line 8 only needs to be an amount for preventing the polymerization in the distillation column 31 between the column top part of the distillation column 31 and the reflux position of the second reflux line 34. This region has a lower temperature compared with that of the column bottom part, and polymerization is hardly caused. Thus, an amount of MQ used in production of high purity acrylic acid can be drastically reduced. Of the production cost of high purity acrylic acid, a cost of the polymerization inhibitor can be substantially suppressed.

In this embodiment, DF trays each having a smaller opening ratio than those of the trays normally used for purification through separation in distillation are provided in the upper part of the distillation column 31, and the DF trays are provided at a smaller interval than the interval of the normal DF trays provided. Thus, this embodiment is more effective from the viewpoints of preventing entrainment of the polymerization inhibitor except MQ and stably producing high quality and low-priced acrylic acid at low cost.

As described above, an MQ consumption in the purification step of high purity acrylic acid through distillation is reduced, to thereby attain more economical production of high purity acrylic acid.

### EXAMPLES

Hereinafter, the present invention will be more specifically described based on examples, but the present invention is not limited thereto.

### Example 1

Acrylic acid was produced using the production apparatus shown in FIG. 1. The distillation column 1 used was a plate column having 20 DF trays and a diameter of 1.5 m. An acrylic acid solution containing 1 mass % each of phenothiazine and hydroquinone, as acrylic acid as a raw material, was fed from the third polymerization inhibitor feed line 14 at 105 kg/h. The acrylic acid as a raw material, to which such agents were fed, was fed to the eighth DF tray of the distillation column 1 at 2,150 kg/h. Air was fed to the bottom part of the distillation column 1 at 8,200 L/h. A column bottom temperature and column top temperature of the distillation column 1 were 72° C. and 57° C., respectively. Further, a pressure in the reflux drum 7 was 3.2 kPa. A bottoms was drawn from the circulation line 3 at 120 kg/h. A composition of the acrylic acid as a raw material before the agents were fed is shown below.

| | | |
|---|---|---|
| Acrylic acid | 99.54 | mass % |
| Acetic acid | 0.06 | mass % |
| Water | 0.06 | mass % |
| Furfural | 0.02 | mass % |
| Benzaldehyde | 0.02 | mass % |
| Maleic anhydride | 0.1 | mass % |

| | |
|---|---|
| Other | balance |

The condensate received in the reflux drum 7 was fed to the reflux liquid feed line 10 at 500 kg/h, to the reflux line 8 at 2,000 kg/h, and to the distillate draw line 12 at 2,190 kg/h. To the reflux liquid feed line 10, an acrylic acid solution containing 4 mass % methoquinone was fed from the first polymerization inhibitor feed line 11 at 19 kg/h. The condensate, to which MQ was fed, was sprayed to an inlet of the condenser 6. To the reflux line 8, an acrylic acid solution containing 1 mass % phenothiazine was fed from the second polymerization inhibitor feed line 13 at 39 kg/h. The condensate, to which phenothiazine was fed, was ref luxed to the twentieth DF tray of the distillation column 1.

To the distillate draw line 12, hydrazine hydrate was fed as a hydrazine compound at 1.6 kg/h. The condensate, to which the hydrazine compound was fed, was stayed in the reaction tank 18 for 1 hour, to thereby polymerize aldehydes and 90 mass % or more of maleic acid by an excess amount of the hydrazine compound. The polymerized condensate was fed to the flasher 19 at 2,191.6 kg/h. A cylindrical column equipped with a device for heating a fed liquid in a bottom part was used as the flasher 19. A temperature and pressure in the flasher 19 was 70° C. and 6.7 kPa, respectively. A column bottom liquid of the flasher 19 was fed no the reboller 4 at 100 kg/h.

A vapor from the column top part of the flasher 19 was condensed in the condenser and MQ was fed to the obtained condensate, to thereby obtain acrylic acid containing 200 mass ppm MQ.

### Example 2

Acrylic acid was produced using the production apparatus shown in FIG. 2, Differences from Example 1 are described below.

A distillation column having 8 DF trays, a layer packed with INTALOX SADDLES (IMTP 40) available from Saint-Gobain Norton KK as packing at a packing height of 3 m thereon, and 3 DF trays thereon was used as the distillation column 31. DF trays each having an opening ratio of 19% were used for the lower 8 DF trays and were provided in an interval of 0.6 m. DF trays each having an opening ratio of 22% was used for the upper 3 DF trays, and was provided in an interval of 0.6 m. The first reflux line 8 was provided to reflux the reflux liquid to the uppermost DF tray, and the second reflux line 34 was provided to reflux the reflux liquid to the uppermost part of the packed layer.

The same acrylic acid as a raw material as in Example 1 was fed from the first feed line 32 at 2,050 kg/h, and an acrylic acid containing 1 mass % each of phenothiazine and hydroquinone was fed from the second feed line 33 at 45 kg/h.

The condensate received in the reflux drum 7 was fed to the first reflux line 8 at 1,000 kg/h, to the second reflux line 34 at 1,000 kg/h, and to the distillate draw line 12 at 2,190 kg/h.

To the first reflux line 8, an acrylic acid solution containing 4 mass % MO was fed from the second polymerization inhibitor feed line 13 at 20 kg/h. To the second reflux line 2, an acrylic acid solution containing 1 mass % each of phenothiazine and hydroquinone was fed from the fifth polymerization inhibitor feed line 35 at 105 kg/h.

The condensate fed to the distilled draw line 12 was fed to the flasher 19 in the same manner as in Example 1, and MQ was fed to the obtained distillate to thereby obtain acrylic acid containing 200 mass ppm MQ.

### Comparative Example

Acrylic acid was produced using the production apparatus shown in FIG. 3, Acrylic acid containing 200 mass ppm MQ was produced in the same manner as in Example 1 except that MQ was fed to the reflux line 8 from the second polymerization inhibitor feed line 13 at 39 kg/h and that the flasher 19 was not used.

An MO amount required for production of 1 kg acrylic acid containing 200 mass ppm MQ, was determined, and resulted in 0.56 g MQ in Example 1, 0.98 g MQ in Example 2, and 1.31 g MQ in Comparative Example.

### INDUSTRIAL APPLICABILITY

According to the present invention, a required amount of MQ used in the purification step through distillation of high purity acrylic acid, which contains no or a trace amount of the polymerization inhibitor except MQ, can be reduced from conventional that. Thus, the cost of the polymerization inhibitor is reduced in production of high purity acrylic acid, and an improvement of the economical efficiency in production of high purity acrylic acid can be attained.

1. A method of producing acrylic acid comprising: distilling acrylic acid in a distillation column; feeding methoquinone to an obtained condensate; refluxing part of the condensate, to which methoquinone was fed, to the distillation column as a reflux liquid; and obtaining acrylic acid as a product from another part of the condensate, to which methoquinone was fed,
wherein the method comprises:
further feeding methoquinone to the reflux liquid;
refluxing the reflux liquid, to which methoquinone was further fed, to a column top part of the distillation column; and
feeding an agent for preventing polymerization of acrylic acid from a lower position compared with a position to which the reflux liquid is refluxed into the distillation column in the distillation column.

2. The method of producing acrylic acid according to claim 1, wherein the agent comprises at least one selected from the group consisting essentially of hydroquinone, phenothiazine, a copper complex, and a manganese complex.
